(19) United States
(12) Patent Application Publication
(10) Pub. No.: US 2009/0135539 A1
(43) Pub. Date: May 28, 2009

(54) ELECTROSTATICALLY ATOMIZING DEVICE

(76) Inventors: Yutaka Uratani, Hikone-shi (JP); Kenji Obata, Hikone-shi (JP); Atsushi Isaka, Hikone-shi (JP)

Correspondence Address: Cheng Law Group, PLLC, 1100 17th Street, N.W., Suite 503, Washington, DC, 20036, US

(21) Appl. No.: 12/277,161

(22) Filed: Nov. 24, 2008

(30) Foreign Application Priority Data
Nov. 27, 2007 (JP) 2007-306623

(51) Int. Cl. H05F 7/00

(52) U.S. Cl. 361/225

(57) ABSTRACT

The electrostatically atomizing device in this invention comprises an emitter electrode, a water supply means, a high voltage source, and an atomization detecting means and further comprises a controller. The water supply means is configured to supply water to the emitter electrode. The high voltage source is configured to apply a high voltage to the emitter electrode so as to electrostatically atomize the water on the emitter electrode. The atomization detecting means is configured to detect a condition where the water is electrostatically atomized from the emitter electrode. The controller is configured to apply a starting voltage upon energization of the device. The controller is configured to apply an operating voltage upon recognition of the condition. The starting voltage is configured to be higher than the operating voltage. With this configuration, it is possible to obtain the electrostatically atomizing device which is configured to generate a mist of charged minute water particles immediately upon energization of the electrostatically atomizing device. It is possible to obtain the electrostatically atomizing device which is configured to generate the mist of the charged minute water particles stably upon recognition of the condition.

### TECHNICAL FIELD

This invention relates to an electrostatically atomizing device being configured to generate a mist of the charged minute water particles by an electrostatically atomization.

### BACKGROUND ART

Japanese patent application publication No. 2007-21370A discloses a prior art electrostatically atomizing device. The electrostatically atomizing device is configured to generate the mist of the charged minute water particles. The prior art electrostatically atomizing device comprises an emitter electrode, an opposed electrode, a water supply means, a controller, and a high voltage source. The opposed electrode is disposed in an opposed relation to the emitter electrode. The high voltage source is configured to apply voltage between the emitter electrode and the opposed electrode. The water supply means is configured to supply water to the emitter electrode.

After energization of the electrostatically atomizing device, the controller starts the high voltage source to apply the high voltage to the emitter electrode. Consequently, a high voltage electric field is generated between the emitter electrode and the opposed electrode. The water is supplied onto the emitter electrode from the water supply means. The water on the emitter electrode is charged by the high voltage electric field. Therefore, a charged water receives Coulomb force. The charged water is pulled toward the opposed electrode by the Coulomb force so that the charged water is formed into a cone shape. A cone shaped water on the emitter electrode is so-called Taylor cone. When the Taylor cone is formed, the Taylor cone is subjected to the high voltage electric field, thereby having its tip which is highly electrically charged. That is, the Taylor cone has at its tip with a high energy. When the high energy exceeds surface tension of the water, breakup is caused at the tip of the Taylor cone. The breakup is so-called Rayleigh breakup. By the Rayleigh breakup, the charged minute water particles are generated from the tip of the Taylor cone. This generation is so-called electrostatically atomization. In this way, the mist of the charged minute water particles is generated from the tip of the Taylor cone.

However, the prior art electrostatically atomizing device takes time to generate the mist of the charged minute water particles. That is, it is impossible for the electrostatically atomizing device to immediately generate the mist of the charged minute water particles after initiation of a device operation.

### DISCLOSURE OF THE INVENTION

The invention is achieved to solve the above mentioned problem. The object of the invention is to provide an electrostatically atomizing device which is configured to generate the mist of the charged minute water particles at short times from the start of the device.

The electrostatically atomizing device in accordance with the present invention comprises an emitter electrode, a water supply means, a high voltage source, and an atomization detecting means. The water supply means is configured to supply water to the emitter electrode. The high voltage source is configured to apply a high voltage to the emitter electrode so as to electrostatically atomize the water on the emitter electrode. The atomization detecting means is configured to detect a condition where the water is electrostatically atomized from the emitter electrode. The feature of the invention resides in that the electrostatically atomizing device further comprises a controller. The controller is configured to control the high voltage source to provide selectively a starting voltage and an operating voltage. The starting voltage is configured to be higher than the operating voltage. The controller is configured to select the operating voltage upon recognition of the condition.

With this configuration, the controller controls the high voltage source to apply the starting voltage when the water on the emitter electrode is not electrostatically atomized. Therefore, it is possible to obtain the electrostatically atomizing device which is configured to generate the mist of the charged minute water particles, immediately. In addition, the controller controls the high voltage source to apply the operating voltage after the atomization detecting means detect the condition where the water is electrostatically atomized from the emitter electrode. Therefore, it is possible to obtain the electrostatically atomizing device which is configured to generate the mist of the charged minute water particles, stably.

It is preferred that the atomization detecting means comprises a discharge current detecting circuit. The discharge current detecting circuit is configured to detect a discharge current flowing from the emitter electrode. The controller is configured to recognize the condition based upon the discharge current.

It is preferred that the electrostatically atomizing device further comprises an opposed electrode. The opposed electrode is disposed in an opposed relation to the emitter electrode. The discharge current detecting circuit is connected to the opposed electrode. The discharge current detecting circuit is configured to detect the discharge current flowing from the emitter electrode to the opposed electrode.

With this configuration, the discharge current detecting circuit is surely capable of detecting the condition. Therefore, it is possible to detect the start of the electrostatically atomization of the water.

It is also preferred that the atomization detecting means comprises a discharge current detecting circuit. The discharge current detecting circuit is configured to detect a discharge current flowing from the high voltage source to the emitter electrode. The controller recognizes the condition based upon the discharge current.

With this configuration, the discharge current detecting circuit is surely capable of detecting the condition. Therefore, it is also possible to detect the start of the electrostatically atomization of the water.

It is preferred that the electrostatically atomizing device further comprises a voltage detecting circuit. The voltage detecting circuit is configured to detect an applied voltage applied to the emitter electrode. The controller controls the high voltage source to keep the applied voltage respectively at the starting voltage and the operating voltage.

In this case, the controller controls the high voltage source to provide the starting voltage and the operating voltage even the applied voltage is differ from the starting voltage and the operating voltage. Therefore, it is possible for the high voltage source to surely apply the starting voltage and the operating voltage even when the applied voltage is differ from the starting voltage and the operating voltage.

It is preferred that the electrostatically atomizing device further comprises an abnormal voltage detecting means. The abnormal voltage detecting means is configured to determine an upper limit and a lower limit of the voltages applied to the emitter electrode. The voltage detecting circuit is configured to detect a voltage value of said applied voltage. The controller is configured to limit when the voltage value becomes higher than the upper limit or becomes lower than the lower limit.

In this case, the applied voltage applied to the emitter electrode is higher than the starting voltage and the operating voltage, and is lower than the upper limit, the abnormal voltage detecting means controls the high voltage source to apply the starting voltage and the operating voltage to the emitter electrode continuously. On the other hand, the applied voltage is higher than the upper limit of the voltage, the abnormal voltage detecting means controls the high voltage source to stop applying the voltage to the emitter electrode. Similarly, the applied voltage is lower than the starting voltage and the operating voltage, and is higher than the lower limit, the abnormal voltage detecting means controls the high voltage source to apply the starting voltage and the operating voltage to the emitter electrode continuously. On the other hand, the applied voltage is lower than the lower limit of the voltage, the abnormal voltage detecting means controls the high voltage source to stop applying the voltage to the emitter electrode. Therefore, even when the high voltage source fails and applies an overhigh voltage to the emitter electrode, the high voltage source is configured to be stopped by the abnormal voltage detecting means.

It is preferred that the electrostatically atomizing device further comprises a protection circuit. The protection circuit is configured to decrease the starting voltage and the operating voltage applied to the emitter electrode when the discharge current becomes higher than a predetermined current.

In this case, even the controller fails and does not control the high voltage source, the voltage applied to the emitter electrode is decreased by the protection circuit. Therefore, it is possible to obtain the electrostatically atomizing device having a high voltage source which is configured to stop applying the high voltage to the emitter electrode when the controller fails.

These and other features and advantages of the present invention will become more apparent from the following best mode for carrying out the present invention and embodiments.

### BRIEF DESCRIPTION OF THE DRAWINGS

FIG. 1 is a graph showing a relation between the applied voltage and generation of the discharge current in this invention.

FIG. 2 is a block diagram of an electrostatically atomizing device of a first embodiment in this invention.

FIG. 3 is a block diagram of the electrostatically atomizing device of a first modification of the embodiment in this invention.

FIG. 4 is a graph showing a relation between each of voltages in this invention.

FIG. 5 is a block diagram of the electrostatically atomizing device of a second modification of the embodiment in this invention.

FIG. 6 is a cross sectional view of the atomizing unit in this invention.

FIG. 7 is a block diagram of an electrostatically atomizing device of a third modification of the embodiment in this invention.

### BEST MODE FOR CARRYING OUT THE INVENTION

Now reference with drawings is made to explain an electrostatically atomizing device in this invention.

### Embodiment

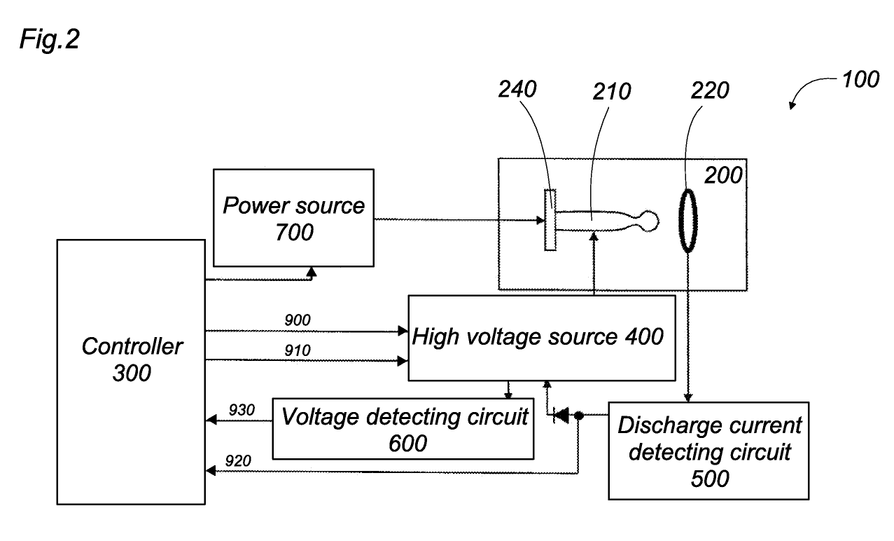

FIG. 2 shows the electrostatically atomizing device 100 in this invention. The electrostatically atomizing device 100 in this embodiment comprises an atomizing unit 200, a controller 300, a high voltage source 400, a discharge current detecting circuit 500, a voltage detecting circuit 600, and a power source 700.

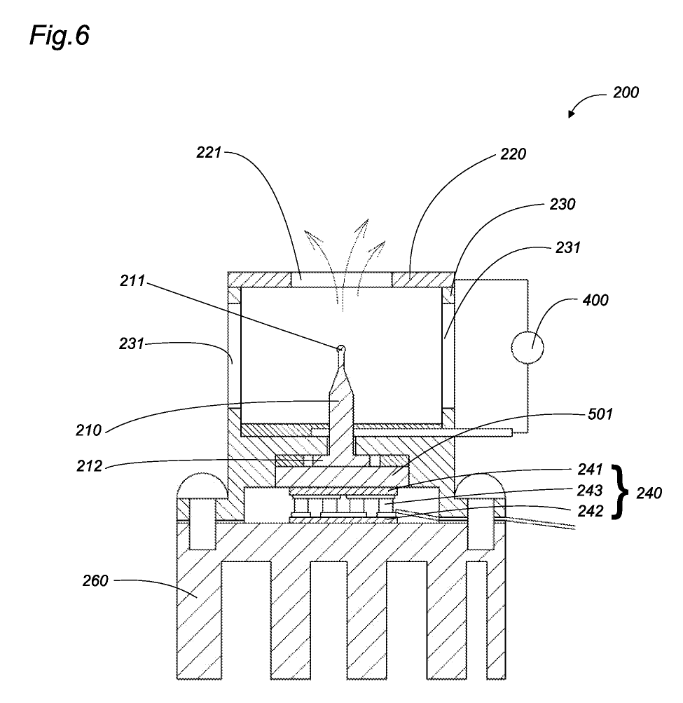

FIG. 6 shows the atomizing unit 200. The atomizing unit 200 is provided for generating a mist of charged minute water particles. The atomizing unit 200 comprises an emitter electrode 210, an opposed electrode 220, an atomizing barrel 230, and a Peltier module 240. It is noted that the Peltier module 240 functions as a water supply means.

The atomizing barrel 230 has tube shape. The atomizing barrel 230 incorporates the emitter electrode 210, the opposed electrode 220, and the Peltier module 240. The atomizing barrel 230 is formed at its circumference wall with apertures 231. The apertures 231 are configured to pass the air from an outside of the atomizing barrel 230.

The emitter electrode 210 has pole shape. The emitter electrode 210 is formed to have an axis. The emitter electrode 210 is disposed at an inside of the atomizing barrel 230. The emitter electrode 210 is disposed to have the axis aligned to an axial direction of the atomizing barrel 230. The emitter electrode 210 is formed at its tip with an emitter end 211 and its rear end with a flange 212.

The opposed electrode 220 is formed to have ring shape with a circular window 221. The opposed electrode 220 is held at a tip of the atomizing barrel 230. Therefore, the opposed electrode 220 is disposed in an opposed relation to the emitter electrode 210. The opposed electrode 220 is formed with the circular window 221 which is configured to flow the air from the inside of the atomizing barrel 230 to the outside of the atomizing barrel 230. In addition, the opposed electrode 220 is not limited to be formed into the ring shape with circular window 221. Furthermore, the opposed electrode is not limited to be held at the tip of the atomizing barrel 230.

The emitter electrode 210 is configured to be energized by the high voltage source 400. Therefore, the high voltage source is configured to apply a high voltage between the emitter electrode 210 and the opposed electrode 220 so as to generate the high voltage electric field between the emitter electrode 210 and the opposed electrode. The high voltage source 400 includes a transformer to apply a predetermined voltage between the emitter electrode 210 and the opposed electrode 220. The high voltage source 400 is configured to apply a negative voltage to the emitter electrode 210. In this embodiment, the high voltage source 400 is configured to apply a negative voltage of −4.8 kV to −5.0 kV. However, the negative voltage is not limited to −4.8 kV to −5.0 kV. On the other hand, the opposed electrode 220 is grounded.

The Peltier module 240 includes a pair of electrically conductive circuit plate 241, 242, and a plurality of thermoelectric conversion elements 243. The conductive circuit plate 241, 242 is made of an electrical insulation material such as alumina and aluminum nitride. The thermoelectric conversion elements 243 are made of a thermoelectric conversion material such as Bi—Te based. A plurality of the thermoelectric conversion elements 243 are arranged in parallel between the electrically conductive circuit plate 241 and the electrically conductive circuit 242. The conductive circuit plate 241 and 242 is configured to be energized from a power source 700 which is shown in FIG. 2. Therefore, the power source 700 is configured to apply the voltage to the thermoelectric conversion elements 243. The Peltier module 240 has the conductive circuit plate 241 as a cooling side and the conductive circuit plate 242 as a heat radiating side. The Peltier module 240 is thermally coupled to the flange 212 of the emitter electrode 210 through a cooling plate 501. Therefore, the Peltier module 240 is configured to cool the emitter electrode 210 when the conductive circuit plate 241 is cooled. On the other hand, the conductive circuit plate 242 is thermally coupled to a heat radiating fin 260. Therefore, heat of the conductive circuit plate 242 transfers to the heat radiating fin 260 when the conductive circuit plate 242 is heated. The heat radiating fin 260 is configured to be cooled by the air which flows through the heat radiating fin 260. Consequently, the heat radiating fin 260 is immediately cooled by the air.

The electrostatically atomizing device 100 generates the mist of the charged minute water particles as follows. The Peltier module 240 is energized by the power source 700 so that the voltage is applied to the thermoelectric conversion elements 243. Then the thermoelectric conversion elements 243 transfer heat from the conductive circuit plate 241 to the conductive circuit plate 242. Consequently, the thermoelectric conversion element 243 cools the conductive circuit plate 241. When the conductive circuit plate 241 is cooled, the cooling plate 501 which is thermally coupled to the conductive circuit plate 241 is cooled. The cooling plate 501 is thermally coupled to the flange 212 of the emitter electrode 210. Therefore, the emitter electrode 210 is cooled by the cooling plate 501. That is, the Peltier module 240 cools the emitter electrode 210 which are thermally coupled by the cooling plate 501. So, a cooled emitter electrode 210 condenses vapor within surrounding the air into the water on the surface of the emitter electrode 210. That is, the Peltier module is configured to cool the emitter electrode 210 to condense the water to the emitter electrode, thereby supplying the water to the emitter electrode 210. Therefore, the Peltier module functions as the water supply means. In this way, the water is supplied to the emitter electrode 210, thereby being supplied to the emitter end 211. In addition, it is also possible that the emitter electrode 210 is formed to have a porous structure. In this case, the water supplied to the emitter electrode is move to the emitter end 211 by capillary action.

The high voltage source 400 is configured to apply the high voltage between the emitter electrode 210 and the opposed electrode. Therefore, the high voltage source 400 generates the high voltage electrical field between the emitter electrode 210 and the opposed electrode 220. The high voltage electrical field pulls the water which is held on the emitter end 211 toward the opposed electrode 220. In this way, the electrical field forms a small Taylor cone at the water held on the emitter electrode 210. In addition, the electrical field forms a small concentration of the electrical charge at the tip of the Taylor cone. As a result, a small discharge current flows from high voltage source through the emitter electrode 210 to the opposed electrode 220. Subsequently, the middle electrical field is caused between the tip of the small charged Taylor cone and the opposed electrode 220. In this situation, the electrical field forms a medium Taylor cone at the water held on the emitter electrode 210. In addition, the electrical field forms a medium concentration of the electrical charge at the tip of the Taylor cone. As a result, a medium electrostatically atomization is caused with a medium discharge current which flows from the high voltage source through the emitter electrode 210 to the opposed electrode 220. And the medium Taylor cone is pulled toward the opposed electrode 220 by a medium Coulomb force. Then, a high voltage electrical field is caused between the tip of the medium charged Taylor cone and the opposed electrode 220. Consequently, the high voltage electrical field forms a large Taylor cone at the water held on the emitter electrode 210. In addition, the electrical field forms a large concentration of the electrical charge at the tip of the Taylor cone. As a result, a large electrostatically atomization is caused with a large discharge current which flows from the high voltage source through the emitter electrode 210 to the opposed electrode 220. Then, the high voltage electrical field causes a high Coulomb force to the tip of the Taylor cone. Subsequently, breakups are caused at the tip of the Taylor cone. The breakup is so-called Rayleigh Breakup. And finally, according to the Rayleigh breakups which are caused at the tip of the Taylor cone, the mist of the charged minute water particles of nanometer sizes is generated from the Taylor cone of the water which is held on the emitter end 211. The mist of the charged minute water particles of nanometer sizes is negatively charged by the emitter electrode 210 applied with the negative voltage. The mist of the charged minute water particles of nanometer sizes is carried by an ion wind which flows from the emitter electrode 210 to the opposed electrode 220. Then, the mist of the charged minute water particles of nanometer sizes is discharged through the circular window 221 of the opposed electrode 220 and flows along the direction of arrows which are shown in the FIG. 6. The mist of the charged minute water particles has small diameters of about nanometer sizes. Therefore, the mist is capable of spreading and floating in the air over an extended time period, thereby adhering to substances which are located in a room where the mist is discharged. In addition, the mist of the charged minute water particles of nanometer sizes includes radicals. Therefore, the mist of the charged minute water particles of nanometer sizes has deodorizing effect and sterilizing effect.

Reverting to FIG. 2, this atomizing unit 200 has the emitter electrode 210 which is energized by the high voltage source 400. The high voltage source 400 is configured to apply −5.0 kV as a starting voltage to the emitter electrode. Furthermore, the controller 300 controls the high voltage source to apply −4.8 kV as an operating voltage to the emitter electrode 200. That is, the starting voltage is configured to be higher than the operating voltage.

The discharge current detecting circuit 500 is provided for detecting the discharge current which flows from the emitter electrode 210 to the opposed electrode 220. The discharge current detecting circuit 500 is defined as an atomization detecting means. The discharge current detecting circuit 500 is connected to the opposed electrode 220 for detecting the discharge current, thereby detecting the discharge current from the emitter electrode 210 to the opposed electrode 220. As above mentioned, the discharge current flows when the electrostatically atomization is caused at the water on the emitter electrode 210. That is, the discharge current detecting circuit 500 is configured to detect a condition where the water is electrostatically atomized from the emitter electrode 210 on the basis of the discharge current which flows from the emitter electrode 210 to the opposed electrode 220. The discharge current detecting circuit 500 is connected to the high voltage source 400 through a diode for sending a current value of the discharge current as a signal. The discharge current detecting circuit 500 is connected to the controller 300 for sending a signal 920 of the current value of the discharge current.

The voltage detecting circuit 600 is configured to detect a voltage value. The voltage detecting circuit 600 is connected to the high voltage source 400, thereby detecting the voltage value of an applied voltage applied to the emitter electrode 210. The voltage detecting circuit 600 is connected to the controller 300 for sending an applied voltage value as a signal 930 shown in FIG. 2.

The controller 300 is configured to send a signal 900 to the high voltage source 400 for starting and stopping the high voltage source 400. The controller 300 is configured to control a power on of the high voltage source 400 after energization of the electrostatically atomizing device 100 by the signal 900. The controller 300 is configured to send a discharge voltage adjusting signal 910 to the high voltage source 400 for adjusting the high voltage applied to the emitter electrode 210. Therefore, the controller 300 is configured to control the high voltage source 400 to provide selectively the starting voltage and the operating voltage. The controller 300 is configured to select the operating voltage on the basis of the condition where the water is electrostatically atomized from the emitter electrode 210. In particular, the controller 300 controls the high voltage source 400 to apply the starting voltage to the emitter electrode 210 upon energization of the electrostatically atomizing device 100. Furthermore, the controller 300 controls the high voltage source 400 to apply the operating voltage to the emitter electrode 210 upon recognition of the condition where the water is electrostatically atomized from the emitter electrode 210.

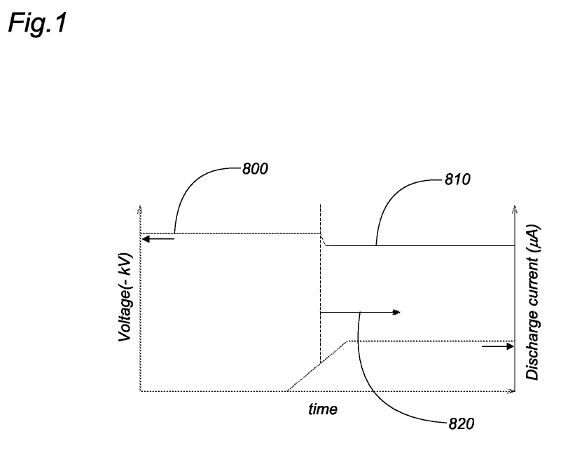

Next, operation of the electrostatically atomizing device 100 is explained with FIG. 1 and FIG. 2. FIG. 1 is a graph which shows the relation between the voltage applied to the emitter electrode 210 and elapsed time from a start of the electrostatically atomizing device 100. The electrostatically atomizing device 100 operates as follows. After a power button which is not shown in the drawings is pressed, the electrostatically atomizing device 100 is energized by an external power source not shown in the drawings. The controller 300 controls the power source 700 to apply the voltage between the plates 241, 242. The controller controls the high voltage source 400 to apply the starting voltage 800 to the emitter electrode 210 as shown in FIG. 1. That is, the controller 300 is configured to control the high voltage source to provide a starting voltage upon energization of the electrostatically atomizing device 100. In addition, the atomizing unit 200 starts as above mentioned. The controller 300 is configured to controls the high voltage source 400 to continuously apply the starting voltage to the emitter electrode 210 until the discharge current detecting circuit 500 detects the discharge current.

After elapse of a certain amount of time, the water on the tip of the emitter end 211 is electrically atomized by the starting voltage which is applied continuously. Then, the discharge current is generated between the emitter electrode 210 and the opposed electrode 220. The discharge current increases with enlargement of the Taylor cone. The discharge current detecting circuit is not configured to detect the small discharge current, and is configured to detect the medium discharge current and the large discharge current. When the discharge current becomes higher than the medium discharge current, the discharge current detecting circuit 500 detects the discharge current. The condition where the water is electrostatically atomized is shown by an arrow with reference numeral of 820 in FIG. 1. With this configuration, the controller 300 is configured to control the high voltage source 400 to apply the starting voltage upon the energization of the electrostatically atomizing device 100. The starting voltage is configured to be higher than the operating voltage. Therefore, it is possible to obtain the electrostatically atomizing device 100 which is configured to generate the mist of the charged minute water particles immediately upon the energization of the electrostatically atomizing device. Subsequently as shown in FIG. 1, the controller 300 is configured to control the high voltage source 400 to provide the operating voltage 810 to the emitter electrode 210 upon recognition of the condition where the water is electrostatically atomized on the basis of the discharge current. Therefore, the electrostatically atomizing device 100 is capable of stably generating the mist of the charged minute water particles upon recognition of the condition.

Furthermore, the electrostatically atomizing device 100 comprises the voltage detecting circuit 600. The voltage detecting circuit 600 is configured to detect the applied voltage applied to the emitter electrode 210. On the basis of the applied voltage, the controller 300 controls the high voltage source 400 to keep the applied voltage respectively at the starting voltage and the operating voltage. In other words, the controller 300 controls the high voltage source 400 to adjust the applied voltage to the starting voltage and the operating voltage. Therefore, it is possible to obtain the electrostatically atomizing device 100 which includes the high voltage source 400 being configured to surely apply the starting voltage and the operating voltage to the emitter electrode 210.

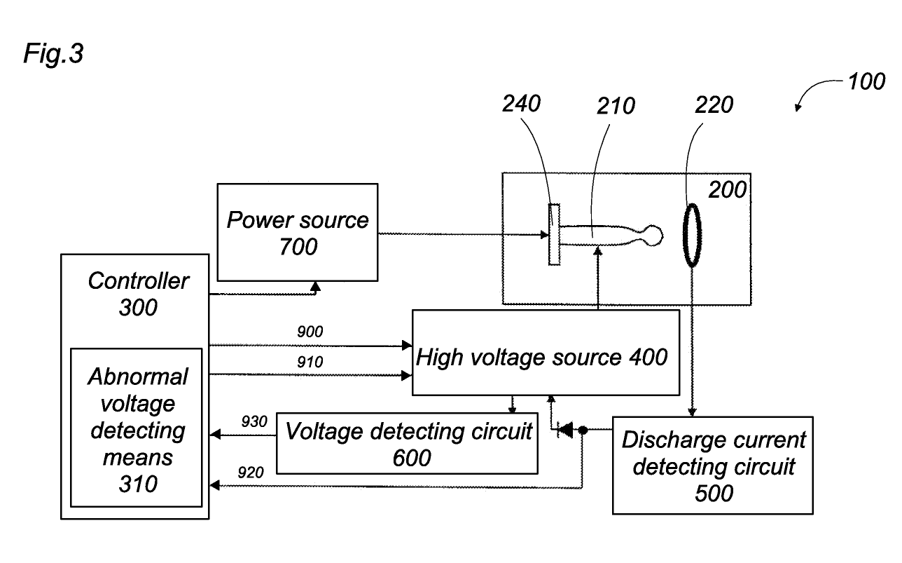

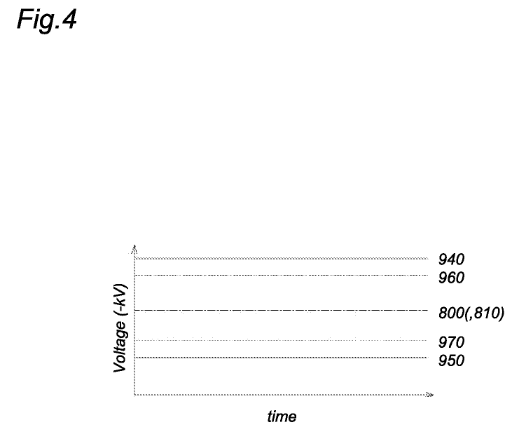

FIG. 3 shows a first modification of the electrostatically atomizing device 100 of the embodiment in this invention. In this modification, the electrostatically atomizing device 100 comprises the controller 300 which has an abnormal voltage detecting means 310. The abnormal voltage detecting means 310 is configured to determine an upper limit 940, a lower limit 950, an upper level voltage 960, and a lower level voltage 970 of the high voltage source 400. FIG. 4 is the graph which shows the relation of the upper limit 940, the lower limit 950, the upper level voltage 960, and the lower level voltage 970 to the starting voltage 800 (or the operating voltage 810) which is detected by the voltage detecting circuit 600. The upper level voltage is higher than the starting voltage and the operating voltage. The upper limit is higher than the upper level voltage. The lower level voltage is lower than the starting voltage and the operating voltage. The lower limit is lower than the lower level voltage.

The controller 300 is configured to stop or continuously drive the high voltage source 400 on the basis of the relation of the upper limit, the lower limit, the upper level voltage, and the lower level voltage to the applied voltage which is detected by the voltage detecting circuit 600. In particularly, the controller 300 is configured to continuously drive the high voltage source 400 when the applied voltage is between the upper level voltage and the upper limit. In this case, the controller controls the high voltage source for adjusting the applied voltage to the starting voltage or the operating voltage. The controller is configured to continuously drive the high voltage source when the applied voltage is between the lower level voltage and the lower limit. In this case, the controller 300 controls the high voltage source for adjusting the applied voltage to the starting voltage or the operating voltage. On the other hand, the controller is configured to limit the high voltage source when the applied voltage is higher than the upper limit. Consequently, the high voltage source 400 is configured to never apply an overhigh voltage to the emitter electrode 210. Similarly, the controller is configured to limit the high voltage source when the applied voltage is lower than the lower limit. Therefore, with this configuration, it is possible to obtain a safe electrostatically atomizing device 100.

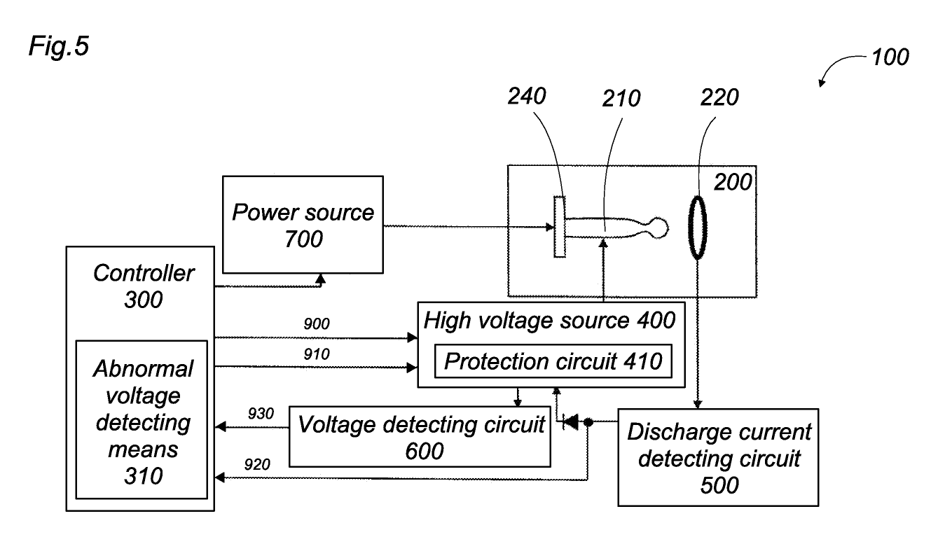

FIG. 5 shows a second modification of the electrostatically atomizing device 100 in this embodiment. In this modification, the electrostatically atomizing device 100 comprises the controller 300 and the high voltage source 400. The controller 300 in this modification is same as the controller 300 in the first modification. The high voltage source 400 comprises a protection circuit 410 as shown in FIG. 5.

The protection circuit 410 is configured to control the high voltage source 400 to decrease the applied voltage which is applied to the emitter electrode 210 on the basis of the discharge current which is detected by the discharge current detecting circuit 500. In particularly, the protection circuit 410 is configured to control the high voltage source 400 to decrease the applied voltage when a current value of the discharge current is higher than a predetermined current.

The discharge current detecting circuit 500 is configured to detect the discharge current, and subsequently is configured to send the current value of the discharge current to the protection circuit 410 of the high voltage source 400. The protection circuit 410 is configured to compare the current value of the discharge current to the predetermined current. The protection circuit 410 is configured to stop the high voltage source 400 when the current value of the discharge current is higher than the predetermined value. The protection circuit 410 is configured to drive the high voltage source 400 continuously when the current value of the discharge current is lower than the predetermined value. That is, the protection circuit 410 is configured to control the high voltage source 400 on the basis of the current value of the discharge current.

Therefore, the high voltage source 400 with the protection circuit 410 is configured to never apply the overhigh voltage to the emitter electrode 210. Consequently, the high voltage source 400 is configured to never apply the overhigh voltage to the emitter electrode 210 even the controller 300 or the voltage detecting circuit 600 fails.

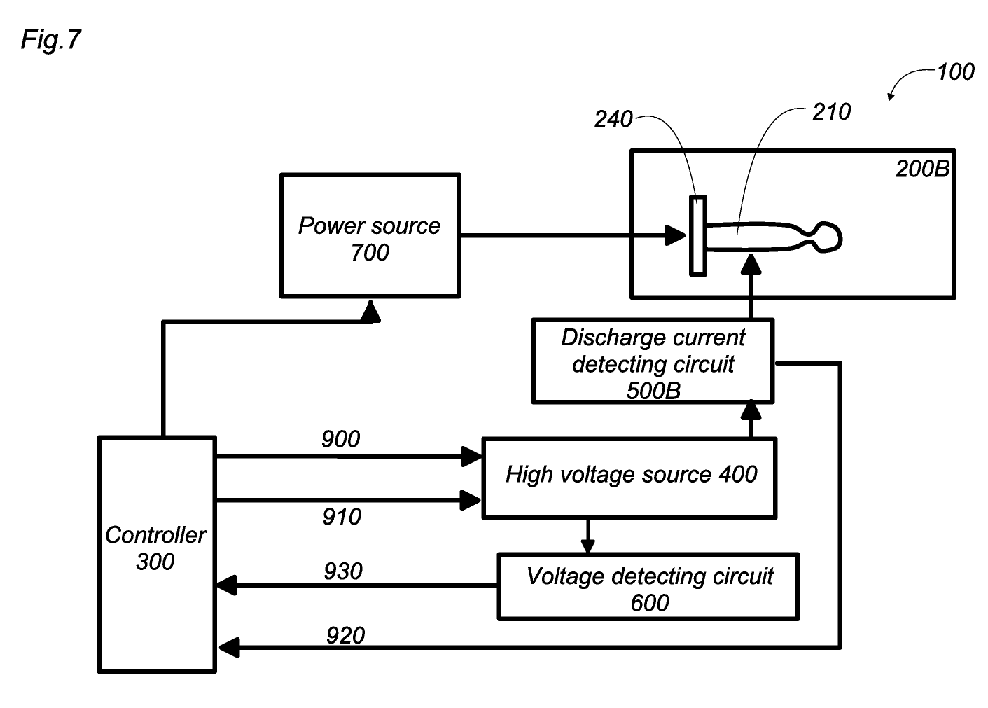

FIG. 7 shows a third modification of this embodiment of the electrostatically atomizing device in this invention. The electrostatically atomizing device of the third modification is substantially equal to that of the first embodiment except for the following features. Therefore, no duplicate explanation to common parts and operations is deemed necessary. Like parts in FIG. 7 are designated by same reference numerals shown in the first embodiment.

As shown in FIG. 7, the electrostatically atomizing device of this modification has an atomizing unit 200B and a discharge current detecting circuit 500B instead of the atomizing unit 200 and the discharge current detecting circuit 500, respectively. The atomizing unit 200B does not have the opposed electrode. The high voltage source 400 is connected to the emitter electrode 210 through the discharge current detecting circuit 500B. Therefore, the high voltage source 400 is configured to apply the high voltage to the emitter electrode 210. The discharge current detecting circuit 500B is configured to detect the discharge current flowing from the high voltage source 400 to the emitter electrode 210. The discharge current detecting circuit 500B is configured to send a detecting signal to the controller 300. The controller 300 is configured to recognize the condition on the basis of the detecting signal.

The high voltage source 400 is configured to apply the high voltage between the emitter electrode 210 and substances which has electrical potential lower than the emitter electrode 210. Therefore, the water on the emitter electrode 210 is electrostatically atomized from the emitter electrode 210. When the water is electrostatically atomized, the discharge current flows from the high voltage source 500B through the emitter electrode 210 to an outside of the atomizing unit 200B. Therefore, the discharge current which flows from the high voltage source 400 to the emitter electrode 210 is detected by the discharge current detecting circuit 500B so that the discharge current detecting circuit 500B generates the signal 920. The signal 920 is send to the controller 300 from the discharge current detecting circuit 500B. Consequently, the controller 300 recognizes the condition on the basis of the signal 920 and controls the high voltage source 400 to apply the operating voltage to the emitter electrode 210.

It is noted that the electrostatically atomizing device 100 in this invention comprises the Peltier module as the water supply means. However, it is preferred that the electrostatically atomizing device comprises a water supply tank instead of the Peltier module 240. In this case, the electrostatically atomizing device further has a water supply path which is configured to supply the water from the water supply tank to the emitter electrode. It is preferred that the water supply path is formed to have a porous structure and is configured to supply water by capillary action. Furthermore, it is possible to change design of the electrostatically atomizing device 400. As one sample, it is possible to use an electrostatically atomizing device without having the opposed electrode. In this case, a housing which incorporates the electrostatically atomizing device acts as the opposed electrode. An energized emitter electrode has a high potential. On the other hand, the housing is not energized by the high voltage source. Therefore, there is a difference in electrical potentials between the emitter electrode 400 and the housing. As a result, the mist of the charged minute water particles is generated from the water on the emitter electrode 400.

Although the present invention is described with particular reference to the above illustrated embodiments, the present invention should not be limited thereto, and should be interpreted to encompass any combinations of the individual features of the embodiments.

1. An electrostatically atomizing device comprising:
an emitter electrode;
a water supply means being configured to supply water to said emitter electrode;
a high voltage source being configured to apply a high voltage to said emitter electrode so as to electrostatically atomize the water on said emitter electrode; and
an atomization detecting means being configured to detect a condition where the water is electrostatically atomized from said emitter electrode,
wherein
said electrostatically atomizing device further comprises a controller which is configured to control said high voltage source to provide selectively a operating voltage and a starting voltage which is higher than said operating voltage, said controller being configured to select said operating voltage upon recognition of said condition.

2. An electrostatically atomizing device as set forth in claim 1, wherein
said atomization detecting means comprises a discharge current detecting circuit which is configured to detect a discharge current flowing from said emitter electrode, said controller is configured to recognizing said condition based upon said discharge current.

3. An electrostatically atomizing device as set forth in claim 2 further comprises an opposed electrode which is disposed in an opposed relation to the emitter electrode,
wherein
said discharge current detecting circuit is connected to said opposed electrode and is configured to detect said discharge current flowing from said emitter electrode to said opposed electrode.

4. An electrostatically atomizing device as set forth in claim 1, wherein
said atomization detecting means comprises a discharge current detecting circuit which is configured to detect a discharge current flowing from said high voltage source to said emitter electrode, said controller recognizing said condition based upon said discharge current.

5. An electrostatically atomizing device as set forth in claim 1, wherein
said electrostatically atomizing device further comprises a voltage detecting circuit being configured to detect an applied voltage applied to said emitter electrode, and
said controller controls said high voltage source to keep said applied voltage respectively at said starting voltage and said operating voltage.

6. An electrostatically atomizing device as set forth in claim 1, wherein
said electrostatically atomizing device further comprises an abnormal voltage detecting means being configured determine an upper limit and a lower limit of said voltages applied to said emitter electrode,
said voltage detecting circuit is configured to detect a voltage value of said applied voltage, and
said controller is configured to limit when said voltage value becomes higher than said upper limit or becomes lower than said lower limit.

7. An electrostatically atomizing device as set forth in claim 2 further comprising a protection circuit which is configured to decrease said starting voltage and said operating voltage applied to said emitter electrode when said discharge current becomes higher than a predetermined current.
